(19) United States
(12) Patent Application Publication
(10) Pub. No.: US 2017/0315918 A1
(43) Pub. Date: Nov. 2, 2017

(54) METHOD FOR STORING OBJECTS IN A STORAGE AND CORRESPONDING SYSTEM

(71) Applicant: NEC Europe Ltd., Heidelberg (DE)

(72) Inventors: Sofia Nikitaki, Darmstadt (DE); Mohamed Ahmed, London (GB); Saverio Niccolini, Neckargemuend (DE)

(21) Appl. No.: 15/525,300

(22) PCT Filed: Nov. 10, 2015
(86) PCT No.: PCT/EP2015/076202

§ 371 Date: May 9, 2017

(30) Foreign Application Priority Data
Nov. 10, 2014 (EP) 14192501.6

(51) Int. Cl. G06F 12/0888

(52) U.S. Cl. CPC G06F 12/0888; G06F 2212/1021; G06F 2212/608

(57) ABSTRACT

A method for storing objects in a storage, wherein the storage has a predetermined capacity, includes providing an expected popularity and an uncertainty of the expected popularity for each of the objects, and selecting a set of the objects for storing in the storage, wherein the set of is selected on the basis of the expected popularity, the uncertainty and the capacity of the storage.

### CROSS REFERENCE TO RELATED APPLICATIONS

This application is a U.S. National Stage Application under 35 U.S.C. §371 of International Application No. PCT/EP2015/076202 filed on Nov. 10, 2015, and claims benefit to European Patent Application No. EP 14192501.6 filed on Nov. 10, 2014. The International Application was published in English on May 19, 2016 as WO 2016/075135 A1 under PCT Article 21(2).

### FIELD

The present invention relates to a method and a system for storing objects in a storage.

### BACKGROUND

A storage allocation strategy is an important business decision that is often followed by high investment and overhead costs. Specifically, the storage assignment policies depend on product demand trends and order picking methods in order to improve productivity. Traditional storage policies allocate products based on their unique identifier and adopt techniques according to different metrics. For example random storage can be utilized in small warehouses due to its simplicity but with the main disadvantage of resulting in longer travel times. On the contrary affinity storage strategies are based on the demand correlation between products and store affine products close to each other. Finally turnover based strategies store the most popular objects in more accessible areas. In this regard it is referred to the non-patent literature of J. Gu, M. Goetschalckx, L. F. McGinnis: “Research on warehouse operation: A comprehensive review”, European Journal of Operational Research 203 (2010) 539-549. While the aforementioned techniques provide a quick mechanism for efficient storage assignment based on the product popularity, they fail to capture the dynamic fluctuations of the product demand caused either by seasonal variations or by the life of the product.

Storing objects in storage is applicable in many cases. In particular, it is applicable in content delivery networks (CDN), for example for cache management due to a given limited capacity of the storage. Content delivery networks rely on a distributed caching infrastructure to cope with the demand of multimedia contents from their Internet users. Due to the ever-changing nature of the contents being requested and the limited resources available—e.g., network bandwidth, cache size, server load—content providers need to implement a caching strategy to place the content in their caches. Traditionally strategies such as Least Recently Used (LRU) take decision of whether or not to evict a content from the cache and make room for a new one based only on the past evolution of requests of the content.

Content delivery networks provide almost two thirds of the Internet video traffic, which in turn represents 66% of all consumer traffic in 2013, and it is expected to represent 79% of the traffic in 2018, excluding peer-to-peer filesharing videos. Companies such as Google, Akamai, and Limelight, offering a bandwidth-intensive content delivery network, conduct a multibillion dollar business based on massively distributed networks of content caches: for instance, in 2010 Akamai, being one of the CDN provider companies, reported that its content delivery networks had over 60.000 servers in 1.000 distinct networks spread over 70 countries.

Therefore, it is advantageous to provide a cost-effective infrastructure that yields good quality of experience to the end users, and at the same time limits the congestion in the network and minimize network latency. CDN providers serve contents to their users by placing caches in their network and adopting caching strategy to select the contents to cache.

Caching strategies are designed to maximize the cache-hit, that is, the number of times users request a content that is already in the cache. In recent years several content caching algorithms have been implemented. Traditional caching policies rely on simple and easy-to-implement approaches such as least-recently-used (LRU), least-frequently-used (LFU) or first-in-first-out (FIFO). Albeit these traditional policies are simple to implement, studies as described e.g. in the non-patent literature of:
Predrag Jelenković, Xiaozhu Kang, and Ana Radovanović, “Near optimality of the discrete persistent access caching algorithm”, DMTCS Proceedings, vol. 0, no. 1, 2006;
“Optimal content placement for peer-to-peer video-on-demand systems”, vol. 21, no. 2, pp. 566-579, 2013;
Qi Huang, Ken Birman, Robbert van Renesse, Wyatt Lloyd, Sanjeev Kumar, and Harry C. Li, “An analysis of facebook photo caching”, in Proceedings of the Twenty-Fourth ACM Symposium on Operating Systems Principles, New York, N.Y., USA, 2013, SOSP '13, pp. 167-181, ACM
   have shown that those mechanisms are far from optimal, as they fail to capture the dynamic growing pattern of user-generated content that follows power law distribution suggesting that most online objects such as videos are popular only for a relatively small portion of their life time.

To overcome the above limitations, solutions based on dynamic programming approaches as described e.g. in the non-patent literatures of
Optimal Cache Allocation for Content-Centric Networking, 2013;
Jiahua Wu and Baochun Li, “Keep cache replacement simple in Peer-Assisted VoD systems,” in INFOCOM '09: IEEE International Conference on Computer Communications, Washington, April 2009, pp. 2591-2595, IEEE Computer Society;
David Applegate, Aaron Archer, Vijay Gopalakrishnan, Seungjoon Lee, and K. K. Ramakrishnan, “Optimal content placement for a large-scale vod system,” in Proceedings of the 6th International COnference, New York, N.Y., USA, 2010, Co-NEXT '10, pp. 4:1-4:12, ACM
   or approaches aiming at finding the optimal solution over time have been proposed. However, their complexity is proportional to the content catalogue size and the capacity of the cache, which make such algorithms impractical for caching at scale.

Least recently used (LRU) is a simple caching mechanism which stores objects into the cache based on which objects received more requests recently. LRU is an eviction technique that has been widely investigated for its hit ratio and for its ease implementation. In this regard it is referred to the non-patent literature of Giuseppe Bianchi, Andrea Detti, Alberto Caponi, and Nicola Blefari Melazzi: “Check before storing: What is the performance price of content integrity verification in lru caching?”, SIGCOMM Comput. Commun. Rev., vol. 43, no. 3, pp. 59-67, July 2013.

Least frequently used (LFU) is another well-known mechanism for caching content. Simply, it stores in the cache the contents that have been most popular so far; and it performs better than LRU when the object requests satisfy the stationary independence reference model (IRM). In this regard it is referred to the non-patent literature of Predrag R. Jelenkovic: “Asymptotic approximation of the move-to-front search cost distribution and least-recently used caching fault probabilities”, The Annals of Applied Probability, vol. 9, no. 2, pp. 430-464, 05 1999.

The non-patent literature of Azer Bestavros and Shudong Jin: “Popularity-aware greedy dual-size web proxy caching algorithms”, in ICDCS 2000, pp. 254-261, IEEE Computer Society discloses a further, more sophisticated, content caching technique.

Furthermore, a k-LRU is a policy that takes from LRU but maintains k−1 virtual caches. In case of a miss, i.e. an object being requested is not in the cache, the object is inserted in the first virtual cache. At every hit, the object is moved to the next virtual cache: K-LRU caches an object that has been already stored in k−1 virtual caches. The LRU policy is used for eviction. The k-LRU scheme holds the desirable properties of LRU while approaches the LFU scheme as the k value increases.

Facebook, being an online social networking service company, currently adopts a first in first out (FIFO) strategy in its photo serving stack as described in the non-patent literature of Qi Huang, Ken Birman, Robbert van Renesse, Wyatt Lloyd, Sanjeev Kumar and Harry C. Li: “An analysis of facebook photo caching”, in Proceedings of the Twenty-Fourth ACM Symposium on Operating Systems Principles, New York, USA, 2013, SOSP '13, pp. 167-181, ACM. However, the document shows that a 4-LRU policy could potentially improve the performance of the multilayer caching scheme. The authors of document M. M Amble, P. Parag, S. Shakkottai and Lei Ying: “Content-aware caching and traffic management in content distribution networks”, in INFOCOM, 2011 Proceedings IEEE, 2011, pp. 2858-2866 consider online eviction decisions in order to improve the quality of service.

The non-patent literature of L. A. Belady: “A study of replacement algorithms for a virtual-storage computer”, IBM Syst. J., vol. 5, no. 2, pp. 78-101, June 1966 deals with an evaluation of several algorithms for the replacement of current information in memory.

The non-patent literature of Bo Tan and L. Massoulie: “Optimal content placement for peer-to-peer video-on-demand systems”, Networking, IEEE/ACM Transactions on, vol. 21, no. 2, pp. 566-579, April 2013 proposes a content placement algorithm for large-scale video on demand systems that considers disk space, link bandwidth, and the skew in content popularity of each video. The proposed technique is based on a mixed integer programming optimization where the Lagrange-relaxation is adopted in order to predict a near-optimal solution. The optimization converges in the orders of hours.

The non-patent literature of Sem Borst, Varun Gupta and Anwar Walid: “Distributed caching algorithms for content distribution networks”, in Proceedings of the 29th Conference on Information Communications, Piscataway, N.J., USA, 2010, INFOCOM '10, pp. 1478-1486, IEEE Press discloses a distributed caching algorithm that exploits the content popularity to provide the most popular objects closer to the network edge.

The traditional approaches as described in the literature bases their caching strategy on the popularity that a given object has gained up to the point. Thus, they fail to capture the temporal dynamics of pattern requests as they consider only the history of content demands for storage assignment.

The non-patent literature of Jeroen Famaey, Frédéric Iterbeke, Tim Wauters and Filip De Turck: “Towards a predictive cache replacement strategy for multimedia content”, J. Network and Computer Applications, vol. 36, no. 1, pp. 219-227, 2013 discloses a future popularity-based cache replacement method. However, the method is not robust to highly variant expectations of popularity values for cached objects.

### SUMMARY

In an embodiment, the present invention provides a method for storing objects in a storage, wherein the storage has a predetermined capacity. The method includes providing an expected popularity and an uncertainty of the expected popularity for each of the objects, and selecting a set of the objects for storing in the storage, wherein the set of is selected on the basis of the expected popularity, the uncertainty and the capacity of the storage.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a schematic view illustrating an architectural overview of a method or a system in accordance with an embodiment of the present invention;

FIG. 2 is a diagram illustrating a cumulative number of requests for 4 million Youtube videos captured in a seven month period on a log-log scale;

FIG. 3 is a diagram illustrating the performance of a method or a system in accordance with an embodiment of the present invention, wherein the performance is illustrated as a function of different risk sensitivity and cache sizes, when the variance of the predictor is small;

FIG. 4 is a diagram illustrating the performance of a method or a system in accordance with an embodiment of the present invention, wherein the performance is illustrated as a function of different risk sensitivity and cache sizes, when the variance of the predictor is large,

FIG. 5 is a diagram illustrating cache replacement performance for various cache sizes in a typical day in terms of the hit ratio when the variance of the content popularity predictor is low;

FIG. 6 is a diagram illustrating cache replacement performance for various cache sizes in a typical day in terms of the hit ratio when the variance of the content popularity predictor is large;

FIG. 7 is a diagram illustrating cache replacement performance for various cache sizes in terms of the hit ratio in a special day when the variance of the content popularity predictor is low; and

FIG. 8 is a diagram illustrating cache replacement performance for various cache sizes in terms of the hit ratio in a special day when the variance of the content popularity predictor is large.

### DETAILED DESCRIPTION

A method and a system are described herein for storing objects in a storage in such a way that the efficiency of the storage is improved.

In accordance with an embodiment of the invention, a method for storing objects in a storage, wherein the storage has a predetermined capacity, includes:
providing an expected popularity and an uncertainty of said expected popularity for each of said objects,
selecting a set of objects for storing in said storage, wherein the set of objects is selected on the basis of said expected popularity, said uncertainty and the capacity of said storage.

According to an embodiment of the invention, a system for storing objects in a storage, wherein the storage has a predetermined capacity, includes:
prediction means adapted to predict an expected popularity and an uncertainty of said expected popularity for each of said objects by the use of a forecasting algorithm,
selection means adapted to select a set of objects for storing in said storage, wherein the set of objects is selected on the basis of said expected popularity, said uncertainty and the capacity of said storage.

The efficiency of the storage can be enormously improved by considering posterior content popularity prediction for maximizing the efficiency of the storage. Thus, the efficiency of the storage can be increased by storing the objects according to the expected popularity of the objects. Further, by considering the uncertainty of the expected content popularity for each object, a method for storing objects in a storage can be robust to highly variant expectations. Thus, according to embodiments of the invention, objects are stored in a storage that has a predetermined, e.g. limited, capacity, wherein an expected popularity and an uncertainty of the expected popularity are provided for each of the objects. The expected popularity and the uncertainty of the expected popularity may be provided by predicting them using a forecasting algorithm. Thus, the expected popularity and the uncertainty of the expected popularity may be predicted for each of the objects by the use of the forecasting algorithm. Hence, popularity values and uncertainty values may be provided for further processing. According to embodiments of the invention a set of objects to be stored in the storage is selected from all available objects, wherein the set of objects is selected on the basis of the expected popularity, the uncertainty and the storage capacity. Thus, the storage may be filled with objects such that the stored objects provide an increase hit probability for requesting users. Hence, the efficiency of the storage is improved.

It is mentioned that the term “object” is to be understood in the broadest sense. For example, objects may include, but are not limited to, content such as multimedia content and/or user-generated content on the Internet, e.g., blogs, videos, news postings, etc. Furthermore, objects may include arbitrary data objects that can be stored in a storage.

Furthermore, it is mentioned that the term “storage” is to be understood in the broadest sense. For example, the storage may be storage area which is part of a greater storage area or of a greater storage. Furthermore, the storage may be a storage entity which is a part of a bigger storage entity or a part of a, e.g. distributed, storage infrastructure. The storage may be a storage medium and/or storage area which is, e.g., more accessible and/or faster accessible and/or easier accessible.

The term “prediction means” may include a prediction entity, e.g. a processor, configured to predict an expected popularity for each of the objects and an uncertainty of the expected popularity by applying a forecasting algorithm.

The term “selection means” may include a selection entity, e.g. a processor, configured to select a set of objects from all available objects for storing in the storage. The selection entity may further be configured to select the set on the basis of the expected popularity, the uncertainty and the capacity of the storage.

The present invention and/or embodiments of the invention may enhance and start from preliminary work where the temporal evolution of content popularity was investigated to model content requests as described, e.g., in the non-patent literature of Stefano Traverso, Mohamed Ahmed, Michele Garetto, Paolo Giaccone, Emilio Leonardi, and Saverio Niccolini: “Temporal locality in today's content caching: Why it matters and how to model it” SIGCOMM Comput. Commun. Rev., vol. 43, no. 5, pp. 5-12, November 2013, that is incorporated herein by reference, and to forecast content popularity growth as described, e.g., in the non-patent literature of Mohamed Ahmed, Stella Spagna, Felipe Huici, and Saverio Niccolini: “A peek into the future: Predicting the evolution of popularity in user generated content” in Proceedings of the Sixth ACM International Conference on Web Search and Data Mining, New York, USA, 2013, WSDM '13, pp. 607-616, ACM, that is also incorporated herein by reference.

According to embodiments of the invention a method for storing objects in a storage may be performed in a memory available to a computation device.

According to embodiments of the invention the storage may be a cache that is, e.g., located in a distributed caching infrastructure. Thus, the method can be advantageously applied in network caching. Known methods utilize the expected number of views in order to pro-actively cache the most popular objects. However, the computational complexity of these methods is high because it is directly related with the learning algorithm. On the contrary, according to an embodiment of the present invention, the embodiment may differ in two different distinct ways, as it could be applied in a massive amount of data such as the catalogue of YouTube videos, i.e. videos of a big video hosting service, and it can provide a risk balancing control that balances the magnitude of content requests, i.e. the popularity, and the uncertainty of the predicted popularity.

According to embodiments of the invention the storage may be a logistic storage such as, e.g., a warehouse. Thus, advantages of an embodiment of the present invention in the context of logistic storage—in contrast to state of the art techniques—are that dynamic fluctuations of content demand can be considered by considering the uncertainty of the expected popularity.

According to embodiments of the invention the uncertainty of the expected popularity, in particular provided by a forecasting algorithm for each of the objects, may include the variance, the standard deviation and/or the relative standard deviation of the expected popularity. Thus, the variance, the standard deviation and/or the relative standard deviation of the expected popularity may be considered to account for the uncertainty of the expected popularity for each of the objects. Hence, a risk-aware storing can be provided.

According to embodiments of the invention the step of selecting the set of objects may be configured in such a way that a hit ratio representing a fraction of requested objects that are placed in the storage is maximized. Thus, the efficiency and utility of the storage can be improved and increased.

According to embodiments of the invention a hit ratio hr(T) over a time interval T may be defined according to

$$hr ( T ) = \frac{{\sum }_{i ∈ {O}_{storage} ⋂ Q ( T )} {p}_{i}}{{\sum }_{i ∈ Q ( T )} {p}_{i}}$$

wherein Q(T) is the number of requested objects during the time interval T, wherein O_{storage} is the set of objects stored in the storage and wherein pᵢ(T) is the true popularity of an object oᵢ for the time interval T.

According to embodiments of the invention the step of selecting the set of objects may include computing a solution of a bi-dimensional knapsack problem such that the hit ratio of requested objects stored in the storage, i.e. the utility of the storage, is maximized, wherein the bi-dimensional knapsack problem considers a capacity constraint and a popularity uncertainty constraint. Thus, the proposed mechanism may consider the output of a forecasting algorithm that is able to predict the popularity growth of specific objects, i.e. the expected number of requests as popularity, with a certain uncertainty. For efficient storing the most valuable objects, a balanced risk optimization problem is performed that trades off between the uncertainty of the prediction such as the standard deviation of the expected popularity and the selection costs such as the capacity of the storage. Specifically, it may be considered a storage that might be a cache or a warehouse with capacity C and a set of N objects characterized with a specific size sᵢ and an expected popularity with mean μᵢ and standard deviation σᵢ. The main objective is to satisfy a predefined number of requests with high probability by selecting K among N objects, where K<N, while satisfying the capacity constraint.

According to embodiments of the invention the step of selecting the set of objects may include computing a solution of a bi-dimensional knapsack problem according to

$${max}_{x} {\sum }_{i = 1}^{N} {μ}_{i} \cdot {x}_{i}$$

which is subject to the constraints that

$${\sum }_{i = 1}^{N} {s}_{i} \cdot {x}_{i} \leq C and {\sum }_{i = 1}^{N} \frac{{σ}_{i}}{{μ}_{i}} \cdot {x}_{i} \leq W and {x}_{i} ∈ \{ 0 , 1 \} , ∀ 1 \leq i \leq N ,$$

wherein μᵢ is the expected popularity for an object oᵢ, wherein xᵢ is 1 for a selected object of that is stored in the storage, wherein xᵢ is 0 for a unselected object of that is not stored in the storage, wherein sᵢ is the size of an object oᵢ, wherein C is the capacity of the storage for establishing a capacity constraint, wherein σᵢ is the standard deviation of an expected popularity pᵢ, and wherein W is a risk envelope for establishing a popularity uncertainty constraint.

According to embodiments of the invention it may be provided that a number of N objects o₁, . . . , o_{N} have expected popularity μ₁, . . . , μ_{N} such that each μᵢ is an unbiased estimator of the true popularity pᵢ, wherein the step of selecting the set of objects is configured such that a probability of being able to serve a predetermined number of requests, i.e. achieving a predetermined threshold, is maximized by computing a solution of an optimization problem according to

$${min}_{x ∈ {\{ 0 , 1 \}}^{N}} \frac{τ - {\sum }_{i = 1}^{N} {μ}_{i} {x}_{i}}{{\sum }_{i = 1}^{N} {σ}_{i} {x}_{i}}$$

which is subject to the constraints that

$${\sum }_{i = 1}^{N} {s}_{i} \cdot {x}_{i} \leq C and {x}_{i} ∈ \{ 0 , 1 \} , ∀ 1 \leq i \leq N ,$$

wherein parameter τ represents the predetermined number of requests, wherein sᵢ is the size of an object oᵢ, wherein xᵢ is 1 for a selected object of that is stored in the storage, wherein xᵢ is 0 for a unselected object oᵢ of that is not stored in the storage, wherein μᵢ is the expected popularity for an object oᵢ, wherein σᵢ is the standard deviation of an expected popularity μᵢ, and wherein C is the capacity of the storage. Thus, an efficient object storage based on the expected number of requests may be provided, wherein the expected number of requests for each object, i.e. the popularity, and the uncertainty of the expectation are considered with the objective to increase and/or maximize the probability of satisfying a predefined number of requests while respecting the capacity constraint. Hence, a risk-aware and demand-based storage method and system are provided and it may be enabled that a minimum number of requests will be satisfied.

According to embodiments of the invention a dynamic programming algorithm may be employed for selecting and/or determining the set of objects. Thus, a dynamic programming algorithm can be applied in order to compute an solution of the optimization problem such that the set of objects is selected while satisfying the constraints. Hence, the optimization problem, e.g. as defined above, may be solved via an integer programming approach.

According to embodiments of the invention a greedy algorithm may be employed and implemented for selecting and/or determining the set of objects, wherein an object that appears to yield the largest profit is iteratively selected while a capacity constraint and/or a popularity uncertainty constraint is/are satisfied. Thus, a large amount of data content/objects may be handled due to the selection procedure.

According to embodiments of the invention the profit of an object may be computed on the basis of an efficiency metric. Thus, in order to solve the optimization problem the greedy algorithm may be applied based on the efficiency of each object.

According to embodiments of the invention the efficiency metric may be specified for each object as

$${e}_{i} = \frac{{μ}_{i}}{{σ}_{i}} , ∀ 1 \leq i \leq N$$

wherein μᵢ is the expected popularity for an object oᵢ, and wherein σᵢ is the standard deviation of an expected popularity μᵢ. Thus, the efficiency metric may consider the relative mean object popularity based on the standard deviation as uncertainty of the expectation.

According to embodiments of the invention the efficiency metric may be specified for each object as

$${e}_{i} = \frac{{μ}_{i}}{\frac{{s}_{i}}{C} + \frac{{w}_{i}}{W}} , ∀ 1 \leq i \leq N$$

wherein μᵢ is the expected popularity for an object oᵢ, wherein sᵢ is the size of an object oᵢ, wherein C is the capacity of the storage, wherein wᵢ is the relative standard deviation σᵢ/μᵢ, wherein σᵢ is the standard deviation of an expected popularity μᵢ, and wherein W is a risk envelope.

According to embodiments of the invention the selected set of objects may be employed for loading an empty storage. Thus, a method or a system in accordance with an embodiment of the invention may be applied in a working mode for an empty storage. The embodiment may be applied in an empty storage where the objective is to load into the storage, e.g. a cache, the set of objects such that the probability of satisfying a predefined number of requests is maximized.

According to embodiments of the invention the selected set of objects may employed for updating the storage at a predetermined time interval. Thus, a method or a system in accordance with an embodiment of the invention may be applied in a temporal mode, where the objects of the storage may be updated in deterministic time intervals. Thus, the storage is efficiently updatable.

According to embodiments of the invention the selected set of objects may be employed for updating the storage on demand, preferably at stochastic time intervals. Thus, a method or a system in accordance with an embodiment of the invention may be applied in demand mode such as in application scenarios where the update of the storage is initiated in stochastic time intervals.

According to the present invention and/or embodiments of the invention a method and a system may be provided that includes a content caching policy that takes advantage of the knowledge regarding the expected user demand for given contents/objects. The uncertainty of the expectation is considered in order to maximize the likelihood of satisfying a predefined number of user requests while respecting the capacity of the storage. The method and/or system according to embodiments of the invention take into account both the past and the expected evolution of requests for a given object as content to decide which objects/contents should be selected to be stored in the storage.

At least one embodiment of the invention was evaluated on real traffic traces collected from a European Point-of-Presence that serves over 30,000 users, over a period of seven months during 2013. The evaluation has shown that using a predictor for estimating the popularity of contents caching policy can be designed which performs up to better than traditional LRU and LFU approaches in terms of cache-hit. Hence, the embodiment of the present invention allows to efficiently and proactively cache the most popular contents by exploiting information on expected popularity of the contents that the users request.

According to embodiments of the invention, it may be provided a method or a system comprising a caching-policy mechanism which takes into account the expected popularity of a given content whose complexity is O(nlog(n)) and/or which provides theoretical bounds of the effectiveness of such mechanism.

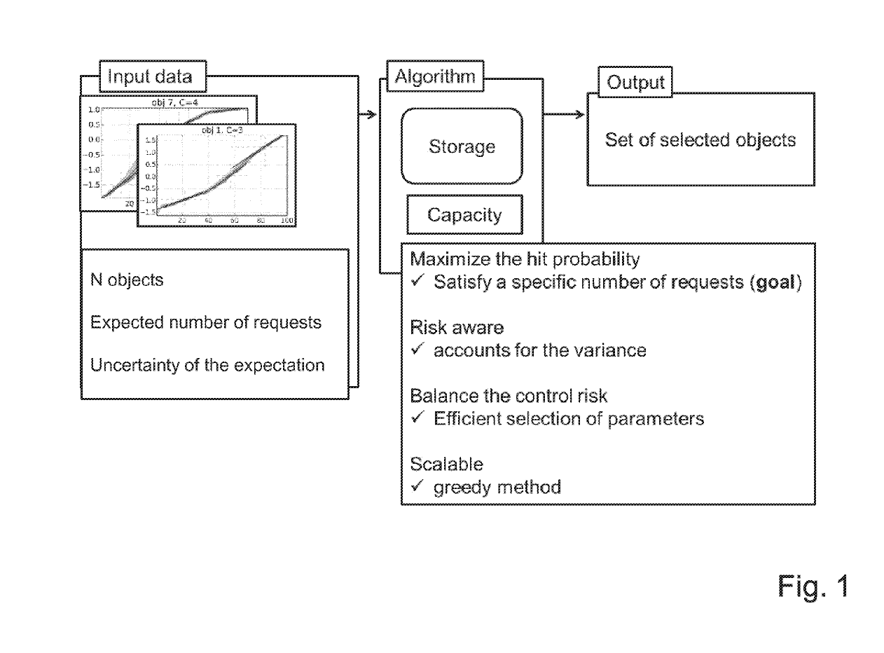

FIG. 1 shows an architectural overview of a method or a system in accordance with an embodiment of the present invention. Traditional approaches fail to capture temporal dynamics of request patterns as they consider only the history of content demands for storage assignment. According to an embodiment of the present invention, this problem is addressed by providing a risk-aware storage system that accounts for the fluctuations of the expected object popularity by considering the uncertainty of the expectation. The proposed mechanism may be applied in a large amount of data due the greedy selection algorithm. Potential use cases may include logistic storage and network caching.

The embodiment depicted in FIG. 1 considers the expected number of requests as expected popularity for N objects together with the corresponding uncertainty. For example, the objects may be products or online contents. Thus, the input data is represented by N objects, the expected number of requests for the objects and the corresponding uncertainty. The algorithm of the embodiment depicted in FIG. 1 determines a set of objects sufficiently in order to balance the magnitude of the object requests and the uncertainty of the object popularity predictor. The set of selected objects represents the output.

In order to increase the accuracy of the proposed mechanism it is required to efficiently and pro-actively select the most popular objects in order to minimize the overhead costs and improve the quality of service. For example an appropriate metric could be considering the cumulative number of requests and selecting the most popular objects implying that what was popular in the past will be popular into the future. However, the dynamic temporal evolution of object requests suggests that the popularity growth does not follow a simple linear trend. For example, it has been observed that the most popular online contents tend to experience sudden significant bursts of popularity.

The algorithm of the embodiment illustrated in FIG. 1 provides a technique that maximizes the probability of satisfying at least a predefined number of user requests which is equivalent of reducing the risk of failing to deliver an object to a user. Thus, it is presented a risk-aware demand system that may
(1) select the set of objects while considering the uncertainty of the expectation,
(2) provide the possibility of selecting designing parameters that balance the control risk of the technique, i.e. the amount of riskiness or conservation of the storage policy, and
(3) be scalable as it can be applied in a large number of objects.

Even though the scenarios hereinafter are related to a distributed caching infrastructure, it will be appreciated by those skilled in the art that the present invention is not limited to method or systems concerning a distributed caching infrastructure, but can be applied in connection with different kind of storage infrastructures. This may also include implementations in the context of logistic storage.

In the following an optimization problem of an embodiment of the present invention as depicted in FIG. 1 is defined. The optimization problem allows to cache efficiently the most popular objects. Specifically, provided an estimation of the number of requests for each object/content for a given time period, the objective is cache the objects that maximize the utility of the cache, i.e. satisfying the user's requests, within the capacity constraint. Thus, a cache memory of capacity C and a catalogue of N objects are considered. Each object oᵢ is characterized with a specific size sᵢ and future content popularity pᵢ(T) for a given time period T. When clear from the context, T is omitted.

Let Q(T) denote the set of requested objects during a time interval T, and O_{cache} be the set of cached objects. Then the hit ratio over T is defined as

$$hr ( T ) = \frac{{\sum }_{i ∈ {O}_{cache} ⋂ Q ( T )} {p}_{i}}{{\sum }_{i ∈ Q ( T )} {p}_{i}}$$

i.e. the fraction of requested objects that are placed in the cache.

The main objective is to maximize the hit ratio by maintaining into the cache a set of objects O*₁ that have the maximum future content popularity and satisfy the capacity constraint. This can be modelled as an instance of a 0,1-knapsack problem:

$$\begin{matrix}{max}_{x} {\sum }_{i = 1}^{N} {p}_{i} \cdot {x}_{i} & ( 2 ) \\ subject to {\sum }_{i = 1}^{N} {s}_{i} \cdot {x}_{i} \leq C & ( 3 ) \\ {x}_{1} ∈ \{ 0 , 1 \} , ∀ 1 \leq i \leq N & ( 4 )\end{matrix}$$

It should be noted that the constraint of formula (4) requires the variables xᵢ to be binary, i.e. xᵢ=1 for all the cached objects.

However, the above assumes that the exact future content popularity pᵢ, i.e. the true popularity, of each object oᵢ is known. Therefore, it is considered the problem when an unbiased estimator μᵢ for each pᵢ is provided, i.e., E(μᵢ)=pᵢ. By replacing pᵢ by μᵢ in formula (2) the expected hit ratio can be maximized. However, solely aiming at maximizing the expected number of views may not result in a satisfactory performance, especially when the future popularity estimates μᵢ suffer from large fluctuations. A typical assumption is that the content popularity predictor provides a content request estimation for object oᵢ that follows some unknown distribution with mean value μᵢ and variance σᵢ². Therefore formula (2) is transformed into a bi-dimensional knapsack problem where the popularity uncertainty constraint is introduced. Let O*₂ be the optimal solution of the following problem:

$$\begin{matrix}{max}_{x} {\sum }_{i = 1}^{N} {μ}_{i} \cdot {x}_{i} & ( 5 ) \\ subject to {\sum }_{i = 1}^{N} {s}_{i} \cdot {x}_{i} \leq C & ( 6 ) \\ {\sum }_{i = 1}^{N} \frac{{σ}_{i}}{{μ}_{i}} \cdot {x}_{i} \leq W & ( 7 ) \\ {x}_{i} ∈ \{ 0 , 1 \} , ∀ 1 \leq i \leq N & ( 8 )\end{matrix}$$

The new constraint of formula (7) defines a risk envelope around the expected number of hits, i.e., when W is large less consideration to the confidence in the expectation of the popularity is given. On the other hand, small W forces to place into the cache objects for which the predicted popularity is assumed to be accurate. Preferably, the relative standard deviation σᵢ/μᵢ is considered instead of the absolute standard deviation oᵢ since the latter would induce a bias towards less popular objects.

A comparison of the two versions of the problem provides Σ_{iεO*}_{₁}μᵢ≧Σ_{iεO*}_{₂}μᵢ, since a solution for the bi-dimensional problem will also be a solution for the one-dimensional problem. Equality can be achieved when either high quality predictions are provided or when being more risk-prone and larger W are allowed. In order to get a better idea how the choice of W influences the quality of the solution, the following scenario may be considered:

Assume it holds σᵢ/μᵢ≈t for all objects. Then, the problem translates to detect the at most W/t objects with the largest popularity that satisfy the capacity constraint.

Based on the previously described optimization problem a cache replacement algorithm is presented.

It is well-known that the decision version of the one-dimensional knapsack problem is NP-complete. However, the problem is solvable in pseudo-polynomial time by dynamic programming. Thus, with regard to the bi-dimensional problem the running time and space complexity for N objects, capacity C and risk envelope W is of the order O(NWC). For larger values of N and W the approach may become impractical. Instead, faster approximation algorithms may be used. While these approximation algorithms are not guaranteed to return an optimal solution, they are often preferred in practical applications as they are easier to implement, are considerably more efficient, and can yield a solution that is very close to the optimal one.

Unlike the one-dimensional version, the bi-dimensional problem does not admit a fully polynomial time approximation scheme (FP-TAS). Several works present polynomial time approximation scheme (PTAS) for the problem based on the LP-relaxation of the problem, see for example chapter 9 in H. Kellerer, U. Pferschy and D. Pisinger: “Knapsack Problems”, Springer, Berlin, Germany, 2004 for an overview.

In order to give some intuition how an optimal solution for the relaxed problem leads to an approximate solution, consider the following approach. Assume that any two objects satisfy the constraints, i.e., sᵢ+sⱼ≦C and μᵢ/σᵢ+μⱼ/σⱼ≦W.

A simple algorithm yields a ½-approximation to the optimal solution. Let x_{OPT} be the optimal solution to the linear relaxation of the original problem, i.e., the constraint xᵢε{0, 1} is replaced with xᵢε[0, 1]. It is known, as may be obtained from, e.g., chapter 9 in H. Kellerer, U. Pferschy and D. Pisinger: “Knapsack Problems”, Springer, Berlin, Germany, 2004 that x_{OPT} contains at most two fractional variables. Assume the variables are sorted in decreasing order such that x_{OPT}=(1, . . . , 1, α, β, 0, . . . , 0) for some 0≦α, β≦1.

Thus, it is now easy to see that either the objects oⱼ of with xⱼ set to 1 in x_{OPT} or the two objects corresponding to the fractional variables yield a ½-approximation of the optimal solution of the original problem.

Even if an optimal solution of the LP-relaxation of the problem can be computed in O(N) steps, this comes at the price of hidden constants in the big O notation and a complex implementation. Instead, in practice it is usual to apply simpler and more intuitive approaches, even if no theoretical guarantees can be obtained.

In accordance with an embodiment of the present invention, an efficient approximation algorithm—as indicated in the overview of FIG. 1—that computes a feasible solution may be implemented as follows:

```
Algorithm 1:
Input: N objects o₁, . . . , o_{N}
  Attributes of object oᵢ: expected number of requests μᵢ, standard
  deviation of the expectation σᵢ, size sᵢ
System’s constraints: capacity C, risk envelope W
Output: set D of selected objects to be cached
$Initialize \text{:} Let {w}_{i} = \frac{{σ}_{i}}{{μ}_{i}} , {e}_{i} = \frac{{μ}_{i}}{{s}_{i} / C + {w}_{i} / W} , ∀ 1 \leq i \leq N .$
Sort the objects in decreasing according to eᵢ.
D = Ø, Cₜₘₚ = 0, Wₜₘₚ = 0.
for i = 1 to N do
  if Cₜₘₚ > C or Wₜₘₚ > W then
    break
  end if
  D = D ∪ oᵢ
  Cₜₘₚ += sᵢ
  Wₜₘₚ += wᵢ
  end for
  return D ← D
```

Algorithm 1 includes a greedy approach that admits a simple and efficient implementation. Hence the algorithm works in a greedy fashion by selecting the object that appears to yield the largest profit. The step is repeated while the capacity and risk envelope constraints are satisfied. Let wᵢ=σᵢ/μᵢ. The profit of object oᵢ is defined as efficiency metric:

$${e}_{i} = \frac{{μ}_{i}}{{s}_{i} \text{/} C + {w}_{i} \text{/} W} ,$$

The intuition is simple: dividing sᵢ and wᵢ by C and W, respectively, normalizes the importance of the weights sᵢ and wᵢ. Thus, sᵢ/C+wᵢ/W is an estimate of the cost of including object oᵢ into the cache with respect to the size and risk envelope constraints and eᵢ roughly computes a profit-to-cost ratio. Upon termination of the algorithm, the cache contains the objects with highest efficiency. In the pseudocode of Algorithm 1, the objects are sorted at first according to their efficiency in order to find the most profitable ones. Comparison-based sorting algorithms need time Ω(N log N). An alternative approach based on finding the weighted median as described in E. Balas and E. Zemel: “An Algorithm for Large Zero-One Knapsack Problems”, 28. Operations Research, 1980, pp. 1130-1154 improves the running time to O(V). However, the result is mainly of theoretical importance since there are large constants hidden in the big-O notation.

Furthermore, the algorithm as indicated in the overview of FIG. 1 may be implemented as follows:

```
Algorithm 2:
  Input: N objects o₁, . . . , o_{N}
  Attributes of object oᵢ: expected number of requests μᵢ,
  standard deviation of the expectation σᵢ, size sᵢ
  System’s constraints: capacity C
  Output: set D of selected objects to be cached
  $Intialize \text{:} Estimate {e}_{i} = \frac{{μ}_{i}}{{σ}_{i}} , ∀ 1 \leq i \leq N .$
  Sort the objects according to eᵢ
  Greedy replacement: Select the objects till the capacity constraint is
  violated.
  return D ← D
```

The greedy selection presented by Algorithm 2 selects a set of objects only based on the efficiency metric eᵢ. However, it might fail in the case where the selected objects violate the capacity constraint but their total number of requests is below the threshold τ.

Furthermore, the algorithm as indicated in the overview of FIG. 1 may be implemented as follows:

```
Algorithm 3:
  Input: N objects o₁, . . . , o_{N}
  Attributes of object oᵢ: expected number of requests μᵢ,
  standard deviation of the expectation σᵢ, size sᵢ
  System’s constraints: capacity C
  Output: set D of selected objects to be cached
  $Intialize \text{:} Estimate {e}_{i} = \frac{{μ}_{i}}{{σ}_{i}} , ∀ 1 \leq i \leq N .$
  Sort the objects according to eᵢ
  Greedy replacement: Select the objects till the capacity constraint is
  violated such that their expected popularity is above the average
  remaining predefined number of requests.
  return D ← D
```

The greedy selection presented by Algorithm 3 sorts the objects based on the efficiency metric eᵢ. The greedy selection algorithm ensures that the selected objects will satisfy the constraints, i.e. serving a minimum number of requests while respecting the capacity constraint. This is accomplished as the expected popularity of each selected object is above the average remaining predefined number of requests. Thus, according to Algorithm 3 the greedy replacement means: Select objects in order of expected popularity until the capacity constraint is violated.

For explanation the probability maximization with regard to embodiments of the invention as indicated in the overview of FIG. 1, let objects o₁, . . . , O_{N} have expected content popularity μ₁, . . . , μ_{N} such that each μᵢ is an unbiased estimator of the true popularity pᵢ. Given a threshold τ, it is wanted to cache those objects that maximize the probability that the total popularity of cached objects is at least τ:

$$\begin{matrix}{max}_{x ∈ {\{ 0 , 1 \}}^{N}} Pr [ {\sum }_{i = 1}^{N} {µ}_{i} {x}_{i} \geq τ ] & ( 9 ) \\ subject to {\sum }_{i = 1}^{N} {s}_{i} \cdot {x}_{i} \leq C & ( 10 ) \\ {x}_{i} ∈ \{ 0 , 1 \} , ∀ 1 \leq i \leq N & ( 11 )\end{matrix}$$

The above version of the problem is known as stochastic knapsack problem. The stochastic knapsack problem has been analyzed in the document Paolo Serafini: “Combinatorial optimization problems with normal random costs”, Oper. Res. Lett., vol. 41, no. 2, pp. 126-133, 2013 under the assumption that popularities are independent of each other and follow Gaussian distribution or normal distribution such that the popularity of the object oᵢ is drawn from N (μᵢ, oᵢ). Under this assumption the optimization problem presented in formula (9) can be transformed to the following:

$$\begin{matrix}{max}_{x ∈ {\{ 0 , 1 \}}^{N}} Pr [ Z \geq \frac{τ - {\sum }_{i = 1}^{N} {µ}_{i} {x}_{i}}{{\sum }_{i = 1}^{N} {σ}_{i} {x}_{i}} ] & ( 12 ) \\ subject to {\sum }_{i = 1}^{N} {s}_{i} \cdot {x}_{i} \leq C & ( 13 ) \\ {x}_{i} ∈ \{ 0 , 1 \} , ∀ 1 \leq i \leq N & ( 14 )\end{matrix}$$

Z of formula (12) represents some popularity value.

The probability of achieving a specific threshold can be maximized by solving the following optimization problem:

$$\begin{matrix}{max}_{x ∈ {\{ 0 , 1 \}}^{N}} \frac{τ - {\sum }_{i = 1}^{N} {µ}_{i} {x}_{i}}{{\sum }_{i = 1}^{N} {σ}_{i} {x}_{i}} & ( 15 ) \\ subject to {\sum }_{i = 1}^{N} {s}_{i} \cdot {x}_{i} \leq C & ( 16 ) \\ {x}_{i} ∈ \{ 0 , 1 \} , ∀ 1 \leq i \leq N & ( 17 )\end{matrix}$$

In the proposed technique the minimum number of satisfied requests, i.e. τ, is a parameter that is related to the selection policy. In case where the goal is relative small compare to the set of most popular objects a risk-averse policy is adopted and the algorithm selects the set of objects that have large mean with low variance. On the contrary, if the requirement is not satisfied, i.e. in case of high goal, the algorithm follows a risk-prone approach and satisfies the objective by selecting objects with large mean and large variance. In the following the asymptotic properties of the proposed maximization problem are proved. Thus, another formulation that works for arbitrary distributions is presented. Hence, the following version of Chemoff inequality is considered (see, for example, chapter 2 in document Fan Chung and Linyuan Lu: “Complex Graphs and Networks”, Cbms Regional Conference Series in Mathematics, American Mathematical Society, Boston, Mass., USA, 2006):

Let X₁, X₂, . . . , X_{N} be nonnegative independent random variables and X=Σᵢ₌₁^{N}Xᵢ. Then

$$Pr [ X \leq E ( X ) - λ ] \leq {e}^{- \frac{{λ}^{2}}{2 {\sum }_{i = 1}^{N} E ( {x}_{i}^{2} )}} .$$

Thus, it may be observed the following. According to the setting of an embodiment according to the invention the random variables Xᵢ will correspond to the estimated/expected popularity and E(Xᵢ)=μᵢ as well as V(Xᵢ)=σᵢ². Furthermore, it is set τ=E(X)−λ. Observe that E(Xᵢ²)=V(Xᵢ)+E(Xᵢ)²=σᵢ²+μᵢ². Thus, given a subset S of videos, that the probability can be bounded such that the total popularity P_{S} will deviate from its expectation as follows

$$Pr [ {P}_{S} \leq {\sum }_{i ∈ S} {μ}_{i} - λ ] \leq {e}^{- \frac{{λ}^{2}}{2 ( {\sum }_{i ∈ S} {σ}_{i}^{2} + {μ}_{i}^{2} )}} .$$

Thus, it is enforced to only look for feasible solutions of maximal expectation whose popularity will not deviate much from the expectation:

$${max}_{S} {\sum }_{i ∈ S} {μ}_{i}$$

$$subject to {\sum }_{i ∈ S} {s}_{i} \leq C$$

$${\sum }_{i ∈ S} {σ}_{i}^{2} + {μ}_{i}^{2} \leq {λ}^{2} \text{/} ( 2 ln \frac{1}{δ} )$$

$${x}_{i} ∈ \{ 0 , 1 \} , ∀ 1 \leq i \leq N$$

The above guarantees that only subsets of videos S are considered where it holds

$$Pr [ X \leq E ( X ) \leq λ ] \leq {e}^{- \frac{{λ}^{2}}{2 {\sum }_{i ∈ S} {σ}_{i}^{2} + {µ}_{i}^{2}}} \leq {e}^{- ln \frac{1}{δ}} = δ$$

Therefore, it may be guaranteed a determination of a solution that will deviate from the expectation by at most λ with probability at least 1−δ for user defined λ, δ>0.

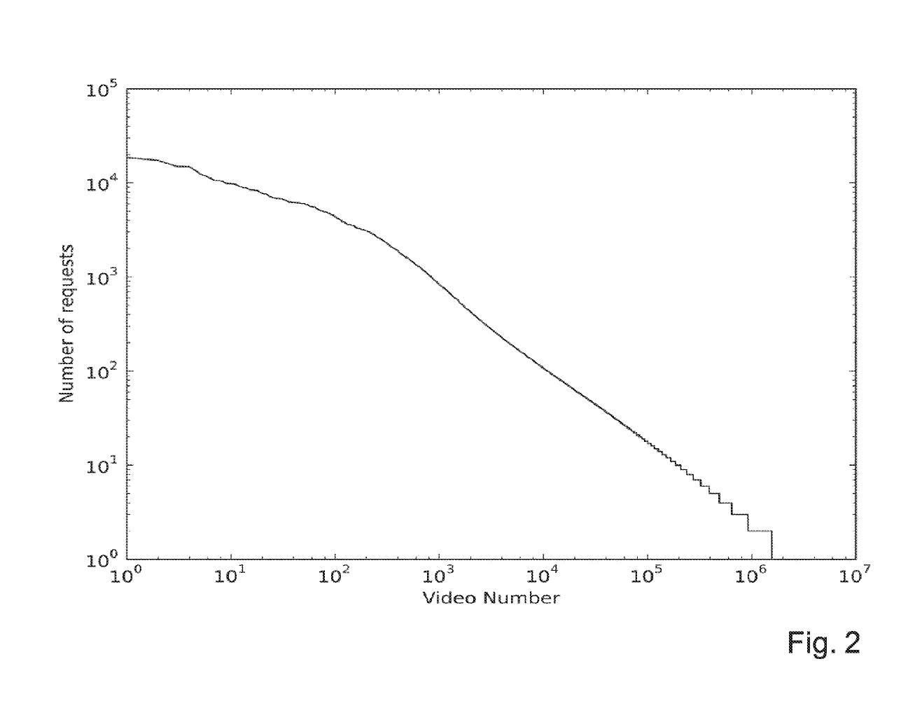

FIG. 2 shows a cumulative number of requests for 4 million Youtube videos captured in a seven month period on log-log scale, whereby it may be observed that the number of request follows a power law distribution. The properties of the proposed cache replacement approach in accordance with an embodiment of the present invention resulted from extensive trace driven simulations were tested and evaluated. The hit ratio is considered as an evaluation metric as described in formula (1). To explore the robustness of the proposed scheme, different variances of the expected content popularity were investigated for various cache sizes and confident envelopes. The effectiveness of the proposed cache policy is compared to the traditional least recently used (LRU) and least frequently used (LFU) that served as a baseline.

The evaluation scenario and the data set rely on passive measurements to characterise the popularity profiles of YouTube videos in operational networks. To this aim, Tstat described for example in the non-patent literature of A. Finamore, M. Mellia, M. Meo, M. M. Munafo, and D. Rossi, “Experiences of internet traffic monitoring with tstat”, Network, IEEE, vol. 25, no. 3, pp. 8-14, May 2011 is an open-source passive sniffer that was utilized with the objective to analyse the packets exchanged by end-users from a vantage point. Tstat was installed on a Point-of-Presence located in a large city of a large European Internet Service Provider (ISP), connecting residential customers through Asymmetric digital subscriber line (ADSL) and Fibre To The Home (FTTH) access technologies. The measurements were collected on both incoming and outgoing traffic carrying YouTube videos for a period of 7 months, from May to November 2013 (i.e. 214 days). The trace considers only TCP flows corresponding to YouTube download requests. The activity of 20 thousand end-users that regularly connecting to the Internet was observed and TCP flows corresponding to almost 16 million Youtube requests and downloads were observed.

A statistical analysis is performed in the collected data in order to obtain the video-view pattern for each requested video in a daily basis. FIG. 2 demonstrates the distribution of the cumulative number of requests for all videos at the last day of the monitored period. The content requests follow a power law distribution. Specifically, the following table summarizes the statistical properties of the video requests, i.e. pattern requests statistics for the 4 million video requests in terms of the total number of views:

| | Standard | | | |
|---|---|---|---|---|
| Mean | deviation | 25% percentile | Median | 95% percentile |
| 4.02 | 51.14 | 1 | 1 | 10 |

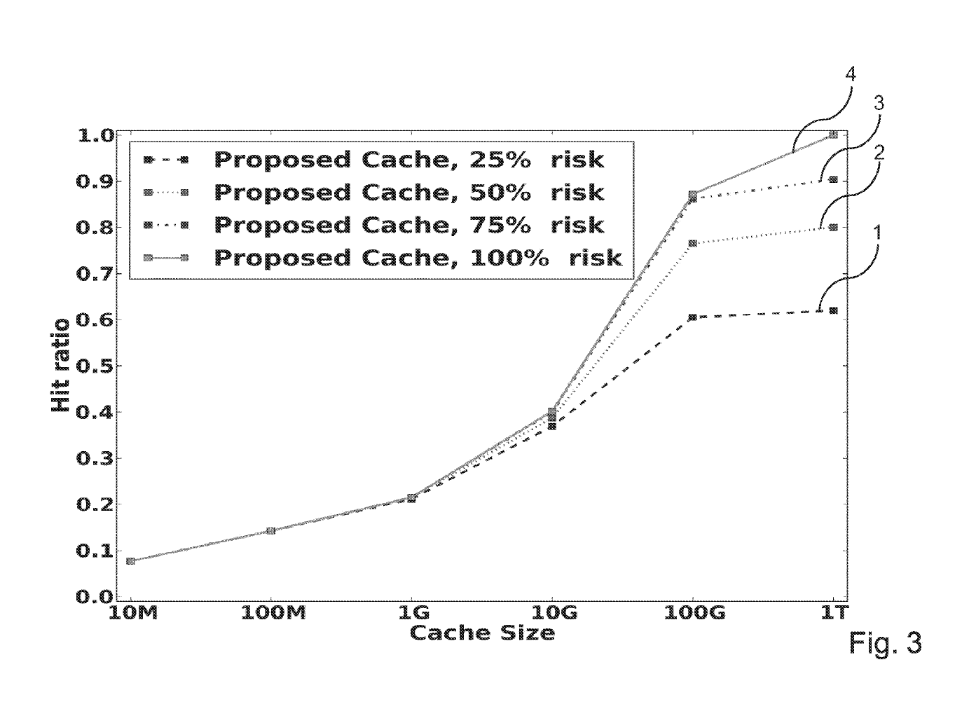

FIG. 3 is a diagram illustrating the performance of a method or a system in accordance with an embodiment of the present invention, wherein the performance is illustrated as a function of different risk sensitivity and cache sizes, when the variance of the predictor is small. Specifically, reference sign 1 represents the proposed caching policy with a risk of 25%, reference sign 2 represents the proposed caching policy with a risk of 50%, reference sign 3 represents the proposed caching policy with a risk of 75% and reference sign 4 represents the proposed caching policy with a risk of 100%.

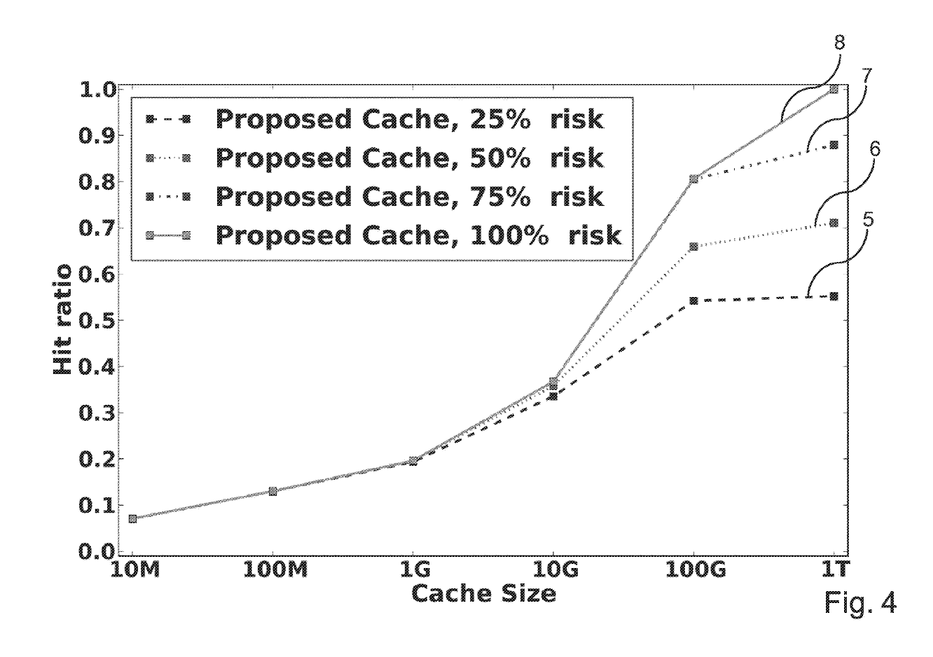

FIG. 4 is a diagram illustrating the performance of a method or a system in accordance with an embodiment of the present invention, wherein the performance is illustrated as a function of different risk sensitivity and cache sizes, when the variance of the predictor is large. Specifically, reference sign 5 represents the proposed caching policy with a risk of 25%, reference sign 6 represents the proposed caching policy with a risk of 50%, reference sign 7 represents the proposed caching policy with a risk of 75% and reference sign 8 represents the proposed caching policy with a risk of 100%.

Thus, the performance of a method or a system in accordance with an embodiment of the present invention, including a cache replacement policy, is presented under different risk sensitivity envelopes and various cache sizes. The robustness of the proposed technique is evaluated under two different scenarios that correspond to low variance of the predictor, i.e. high accuracy, and large variance of the predictor, i.e. low accuracy. FIG. 3 and FIG. 4 depict the performance in these two cases. As the cache size increases the accuracy of the caching policy increases.

Furthermore, the accuracy of a method or a system in accordance with an embodiment of the present invention is compared with respect to traditional caching policies under different noise variance of the predictor and in two different scenarios. The first scenario corresponds to a typical day while the second scenario corresponds to a particular day where the content popularity demand presents intense temporal fluctuations.

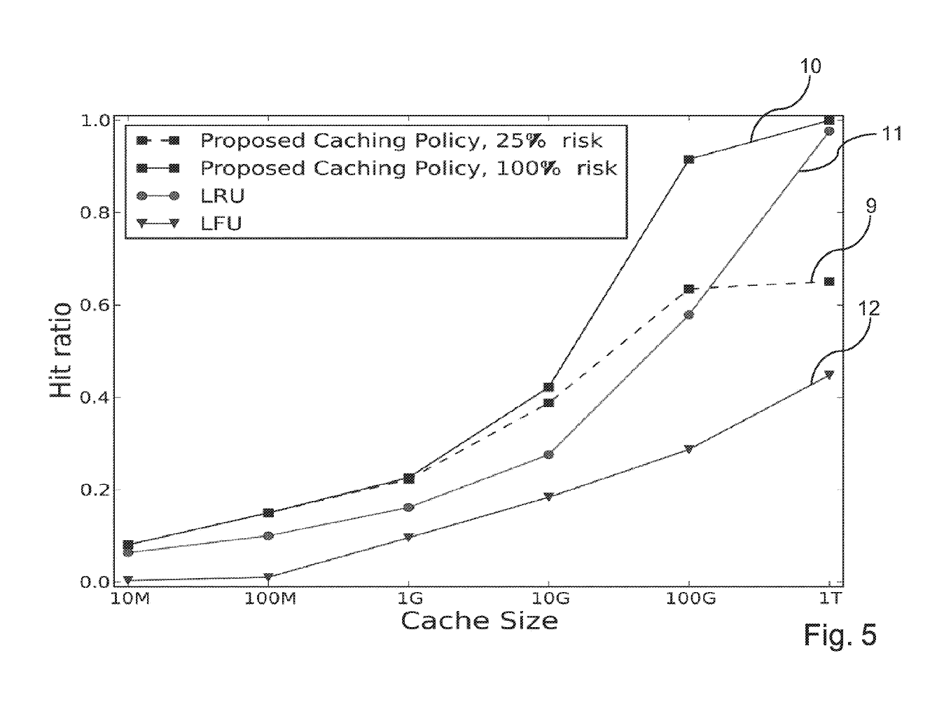

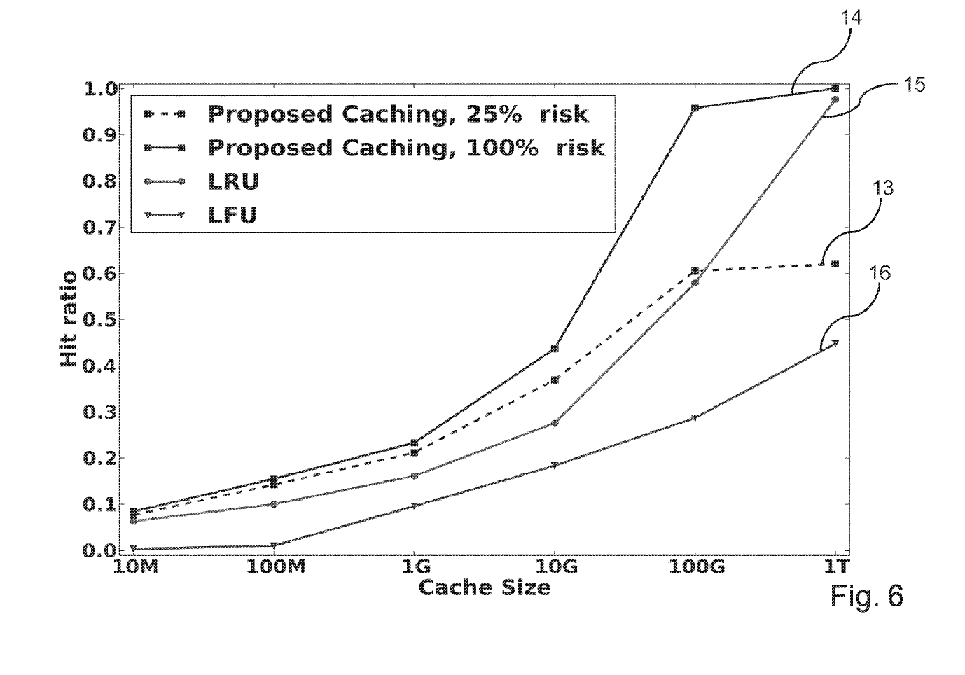

FIG. 5 and FIG. 6 depict the performance of an embodiment of the present invention for various cache sizes under different noise variances in a typical day. In both cases it may be observed that the proposed policy outperforms the traditional policies especially for small case sizes.

Thus, FIG. 5 is a diagram illustrating cache replacement performance for various cache sizes in a typical day in terms of the hit ratio when the variance of the content popularity predictor is low. Specifically, in FIG. 5, reference sign 9 represents the proposed caching policy with a risk of 25%, reference sign 10 represents the proposed caching policy with a risk of 100%, reference sign 11 represents a LRU policy and reference sign 12 represents a LFU policy.

FIG. 6 is a diagram illustrating cache replacement performance for various cache sizes in a typical day in terms of the hit ratio when the variance of the content popularity predictor is large. Specifically, in FIG. 6, reference sign 13 represents the proposed caching policy with a risk of 25%, reference sign 14 represents the proposed caching policy with a risk of 100%, reference sign 15 represents a LRU policy and reference sign 16 represents a LFU policy.

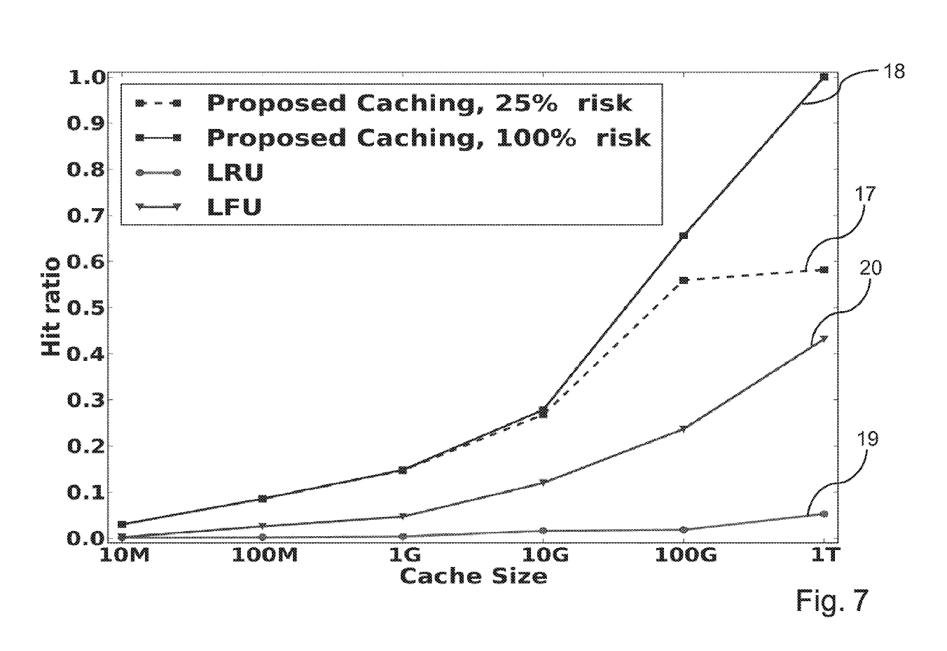

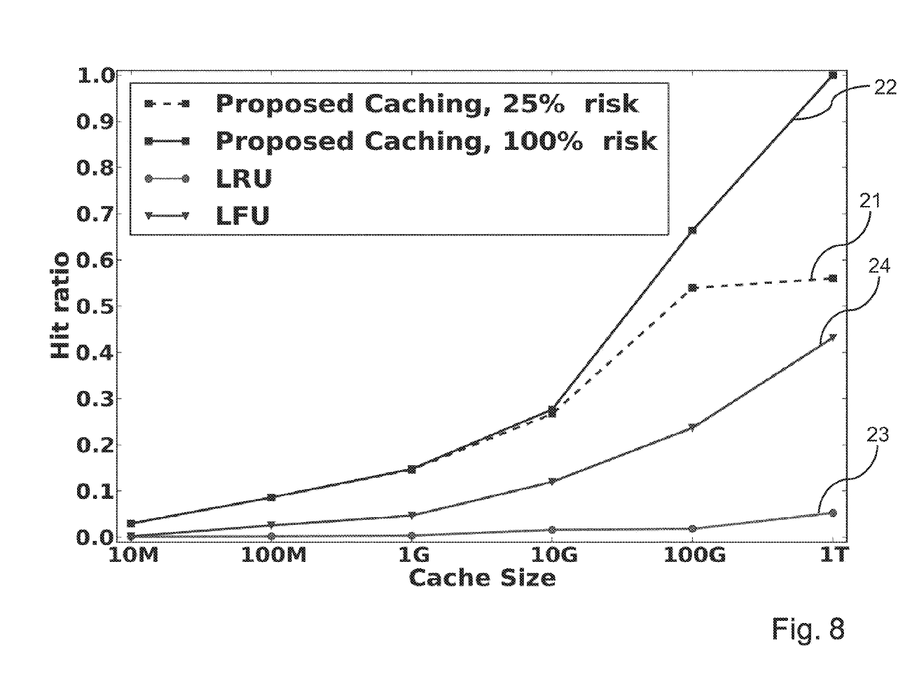

On the contrary, FIG. 7 and FIG. 8 indicate the performance of an embodiment of the present invention in a special day. Compared to LRU and LFU the embodiment of the invention provides a mechanism that captures the dynamic temporal fluctuation of content demand resulting in higher hit ratios.

Thus, FIG. 7 is a diagram illustrating cache replacement performance for various cache sizes in terms of the hit ratio in a special day when the variance of the content popularity predictor is low. Specifically, in FIG. 7, reference sign 17 represents the proposed caching policy with a risk of 25%, reference sign 18 represents the proposed caching policy with a risk of 100%, reference sign 19 represents a LRU policy and reference sign 20 represents a LFU policy.

FIG. 8 is a diagram illustrating cache replacement performance for various cache sizes in terms of the hit ratio in a special day when the variance of the content popularity predictor is large. Specifically, in FIG. 8, reference sign 21 represents the proposed caching policy with a risk of 25%, reference sign 22 represents the proposed caching policy with a risk of 100%, reference sign 23 represents a LRU policy and reference sign 24 represents LFU policy.

Hence, an embodiment of the present invention may provide a new caching policy that leverages content popularity prediction algorithms. Through extensive evaluation on real data it could be confirmed that for a reasonably good estimation of future popularity, the proposed approach outperforms widely used cache policies like LFU and LRU.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: A method for storing objects in a storage, wherein the storage has a predetermined capacity, the method comprising:
providing an expected popularity and an uncertainty of the expected popularity for each of the objects,
selecting a set of the objects for storing in the storage, wherein the set of is selected on the basis of the expected popularity, the uncertainty and the capacity of the storage.

2: The method according to claim 1, wherein the storage is a distributed caching infrastructure or a logistic storage.

3: The method according to claim 1, wherein the uncertainty includes one or more of the variance, the standard deviation, and/or the relative standard deviation of the expected popularity.

4: The method according to claim 1, wherein the selecting the set of the objects is configured in such a way that a hit ratio representing a fraction of requested objects that are placed in the storage is maximized.

5: The method according to claim 1, wherein a hit ratio hr(T) over a time interval T is defined according to
$$hr ( T ) = \frac{{\sum }_{i ∈ {O}_{storage} ⋂ Q ( r )} {p}_{i}}{{\sum }_{i ∈ Q ( T )} {p}_{i}}$$
wherein Q(T) is the number of requested objects during the time interval T, wherein O_{storage} is the set of objects stored in the storage and wherein pᵢ(T) is the popularity of an object oᵢ for the time interval T.

6: The method according to claim 1, wherein the step of selecting the set of the objects includes computing a solution of a bi-dimensional knapsack problem such that the hit ratio of requested objects stored in the storage is maximized, wherein said bi-dimensional knapsack problem considers a capacity constraint and a popularity uncertainty constraint.

7: The method according to according to claim 1, wherein the step of selecting the set of the objects includes computing a solution of a bi-dimensional knapsack problem according to
$${max}_{x} {\sum }_{i = 1}^{N} {μ}_{i} \cdot {x}_{i}$$
which is subject to the constraints that
$${\sum }_{i = 1}^{N} {s}_{i} \cdot {x}_{i} \leq C and$$
$${\sum }_{i = 1}^{N} \frac{{σ}_{i}}{{μ}_{i}} \cdot {x}_{i} \leq W and$$
$${x}_{i} ∈ \{ 0 , 1 \} , ∀ 1 \leq i \leq N$$
wherein μᵢ is the expected popularity for an object oᵢ, wherein xᵢ is 1 for a selected object oᵢ, wherein xᵢ is 0 for a unselected object oᵢ, wherein sᵢ is the size of an object oᵢ, wherein C is the capacity of the storage, wherein σᵢ is the standard deviation of an expected popularity μᵢ, and wherein W is a risk envelope for a popularity uncertainty constraint.

8: The method according to claim 1, wherein a number of N objects o₁, . . . o_{N} have expected popularity μ₁, . . . , μ_{N}, wherein the step of selecting the set of the objects is configured such that a probability of being able to serve a predetermined number of requests is maximized by computing a solution of an optimization problem according to
$${min}_{x ∈ {\{ 0 , 1 \}}^{N}} \frac{τ - {\sum }_{i = 1}^{N} {µ}_{i} {x}_{i}}{{\sum }_{i = 1}^{N} {σ}_{i} {x}_{i}}$$
which is subject to the constraints that
$${\sum }_{i = 1}^{N} {s}_{i} \cdot {x}_{i} \leq C and$$
$${x}_{i} ∈ \{ 0 , 1 \} , ∀ 1 \leq i \leq N$$
wherein parameter τ represents the predetermined number of requests, wherein sᵢ is the size of an object oᵢ, wherein xᵢ is 1 for a selected object oᵢ, wherein xᵢ is 0 for a unselected object oᵢ, wherein μᵢ is the expected popularity for an object oᵢ, wherein σᵢ is the standard deviation of an expected popularity μᵢ, and wherein C is the capacity of the storage.

9: The method according to claim 1, wherein a dynamic programming algorithm is employed for selecting the set of the objects.

10: The method according to claim 1, wherein a greedy algorithm is employed for selecting the set of the objects, wherein an object that appears to yield the largest profit is iteratively selected while a capacity constraint and/or a popularity uncertainty constraint is/are satisfied.

11: The method according to claim 1, wherein an object's profit is computed on the basis of an efficiency metric.

12: The method according to claim 1, wherein the efficiency metric is specified as
$${e}_{i} = \frac{{μ}_{i}}{{σ}_{i}} , ∀ 1 \leq i \leq N$$
wherein μᵢ is the expected popularity for an object oᵢ, and wherein σᵢ is the standard deviation of an expected popularity μᵢ.

13: The method according to claim 1, wherein the efficiency metric is specified as
$${e}_{i} = \frac{{μ}_{i}}{\frac{{s}_{i}}{C} + \frac{{w}_{i}}{W}} , ∀ 1 \leq i \leq N$$
wherein μᵢ is the expected popularity for an object oᵢ, wherein sᵢ is the size of an object oᵢ, wherein C is the capacity of the storage, wherein wᵢ is the relative standard deviation σᵢ/μᵢ, wherein σᵢ is the standard deviation of an expected popularity μᵢ, and wherein W is a risk envelope.

14: The method according to claim 1, wherein the selected set of objects is employed for loading an empty storage, and/or
wherein the selected set of objects is employed for updating the storage at a predetermined time interval, and/or
wherein the selected set of objects is employed for updating the storage on demand, preferably at stochastic time intervals.

15: A system for storing objects in a storage, wherein the storage has a predetermined capacity, the system comprising:
a prediction processor configured to predict an expected popularity and an uncertainty of the expected popularity for each of the objects, by use of a forecasting algorithm, and
a selection processor configured to select a set of objects for storing in the storage, wherein the set of objects is selected on the basis of the expected popularity, the uncertainty and the capacity of the storage.
